(19) United States
(12) Patent Application Publication
(10) Pub. No.: US 2003/0132545 A1
(43) Pub. Date: Jul. 17, 2003

(54) Flexible moulds for injection moulding and injection moulding methods using same

(76) Inventor: Paul Anthony Shepheard, Cambridgeshire, MA (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/297,039

(22) PCT Filed: May 30, 2001
(86) PCT No.: PCT/GB01/02387

(30) Foreign Application Priority Data
May 30, 2000 (GB) 0013092.2

(51) Int. Cl. B29C 33/40

(52) U.S. Cl. 264/227; 264/328.1; 264/337

(57) ABSTRACT

A method of producing a mould by forming around a pattern (20, 21) of an article to be produced comprises, (a) pressing a mould matrix (50) material around said pattern (20, 21) in a chamber bounded by solid retaining means (40, 80); (b) causing said mould matrix (50) material to harden to produce a flexible mould (50) having the following physical properties; flexural strength in the range 20-175 Mpa; flexural modulus in the range 700-5,000 Mpa; tensile strength in the range 10-120 Mpa; tensile modulus in the range 850-4,000 Mpa; compressive strength in the range 30-200 Mpa; compressive modulus in the range 400-5,000 Mpa; hardness in the range 5-20 Vickers; relative density in the range 0.5 to 3.0 g/cm³, and (c) removing the pattern (20, 21) to leave a mould (50), conforming to the pattern; wherein said mould matrix material (50) contains from 10 to 90% by volume of fibres, said fibres having a length in the range from 10 to 1000 μm and a thickness in the range from 0.1 to 30 μm.

The present invention relates to component design and, in particular, to a method and system for producing verified component designs and to assist in tool design to near-production specification in the materials of choice, via production processes and in considerably shorter time scales than has previously been-possible.

The reference in the preceding paragraph to “materials of choice” means that the present invention allows a designer or design engineer to make components for verification using the material that will ultimately be used to form such components in a production run. Similarly, the reference to “production processes” means that the present invention enables the component designer to verify the design using a production technique which simulates the conditions that will be used to form such components in a production run.

Traditionally, pattern makers and tool makers have undertaken key roles in bringing new component designs through design evaluation, development and modification to production standards. Until comparatively recently, such work was labour-intensive, time consuming and, as a result, costly. More recently, computer aided design has enabled some of the early evaluation steps to be carried out before a new design is reduced to a 3-D prototype. Nevertheless, a point is inevitably reached during design evaluation when a 3-D prototype of the new design is required.

So-called “rapid prototyping” techniques have been developed which enable designs to be produced in 3-D form using a variety of techniques now well established in the art. Such rapid prototyping methods allow compression of timescale in the production of a component master pattern.

The drawback of current rapid prototyping methods is that the 3-D representation which results is not necessarily made from the production material of choice and, in any case is not made via a production process For example, one known rapid prototyping method is so-called “laminated object manufacturing” in which the computer design is recreated in 3-D form as a multiplicity of laminated layers. A component master pattern is produced in a material, such as paper, which is easily laid down as thin layers bonded together. However, some form of tool then needs to be made to produce a mould for replicating the design in the correct material using a production process. The rapidly-produced prototype or simulant material part is only of limited use in the evaluation process because the material from which it has been produced and/or the method by which it has been produced are not the same as the material and/or method that will be used in full scale production.

Despite these limitations, if evaluation of the rapidly-produced prototype is favourable, the conventional methods of producing a mould tool, using traditional tool room methods or, alternatively, using sintered or resin based materials, must then be employed to take the verification process forward. As discussed above, these known methods are costly and time-consuming to implement, and have their own particular limitations regarding parameters such--as temperature, geometry, pressure and surface finish.

It is also true that the time and cost penalties of changing component design and hence tooling when modifications are required will influence the majority of designers to follow a well-defined, minimal risk path based on their experience. This means that they tend to be inhibited about deviating from conventional techniques.

In the Applicants' granted British patent no. 2344065, an intermediate verification step was described which enables a quickly-produced component to be obtained from a master pattern, in the material of the designer's choice and using a production process. The limitation of this earlier invention is that its use must be restricted to materials which are suitable for moulding at moderate pressures of the order of 15.5 MPa (1 ton-force per square inch) or below. Such pressures are typically found in compression moulding or low pressure injection moulding. At pressures significantly higher than this threshold value, the compressive strength capability of the mould matrix material is jeopardised and mould failure may result.

British Patent no. 1278017 describes a system for moulding spectacle-frame parts using a silicone rubber tool as a mould into which a curable liquid epoxy resin is poured prior to curing by heat. Such a tool is unsuitable for use in injection moulding applications.

European Patent Application no. 0781639 discloses a photocured resin mould containing a reinforcing agent. Typically, the mould is an epoxy system which results in a very hard and inflexible tool, which was hitherto believed to be necessary to withstand the pressures encountered in high pressure injection moulding without deformation of the mould cavity. Unfortunately, such rigidity results in brittleness and a tendency to premature tool failure.

European Patent Application no. 0687538 is another document disclosing a hard, inflexible epoxy resin tool system, with its attendant disadvantage of failure due to brittleness.

It is therefore an object of the present invention to overcome the pressure limitation outlined above. It is also an object of the present invention to provide a method of producing designs in the material of choice with relative ease, relatively quickly and cost effectively compared to conventional methods. It is another object of the invention to provide a method of producing components via a production process. It is a further object of the invention to enable verification of component design to be carried out prior to commitment to high cost tooling upon finalisation of a design. It is a still further object of the invention to provide a process which enables design iteration to be carried out relatively easily and cheaply, thereby giving both engineers and designers greater design freedom before commitment and with a hitherto unattainable degree of confidence that the resulting production parts will satisfy the design criteria.

In a first aspect, the invention is a method of producing an injection moulding tool by forming said tool around a pattern of an article to be produced, the method comprising:

(a) pressing a mould matrix material around said pattern in a mould former or bolster bounded by solid retaining means;

(b) causing said mould matrix material to harden to produce a tool having the following physical properties:

flexural strength in the range 20-175 MPa;

flexural modulus in the range 700-5,000 MPa;

tensile strength in the range 10-120 MPa;

tensile modulus in the range 850-4,000 MPa;

compressive strength in the range 30-200 MPa;

compressive modulus in the range 400-5,000 MPa;

hardness in the range 5-20 Vickers;

density in the range 0.5-3.0 g/cm³, and

(c) removing the pattern to leave a tool conforming to the profile of the pattern, wherein said mould matrix material contains from 10 to 90% by volume of fibres, said fibres having a length in the range from 10 to 1000 μm and a thickness in the range from 0.1 to 30 μm.

Preferably, the fibres are formed from a refractory material and may be selected from the group of materials consisting of carbon, aramid, boron nitride, ceramic (including glass), buckminsterfullerene, as well as nanotubes formed from the above materials.

Optionally, the following additional steps may be carried out to produce components having the features of the master pattern, but in the materials of choice:

(d) forming or moulding an article in the mould cavity under production-representative conditions of temperature and pressure, and

(e) removing the article from the mould cavity.

Advantageously the flexible moulding medium has a flexural strength in the range 30 to 80 MPa and preferably around 50 to 60 MPa.

Advantageously, the flexible moulding medium has a flexural modulus in the range 1500 to 3500 MPa and preferably around 2200 to 2700 MPa.

Advantageously, the flexible moulding medium has a tensile strength in the range 20 to 60 MPa and preferably around 25 to 35 MPa.

Advantageously, the flexible moulding medium has a tensile modulus in the range 1500 to 2500 MPa and preferably around 1750 to 2250 MPa.

Advantageously, the flexible moulding medium has a compressive strength in the range 50 to 105 MPa and preferably around 75 to 85 MPa.

Advantageously, the flexible moulding medium has a compressive modulus in the range 500 to 2500 MPa and preferably around 600 to 1500 MPa.

Advantageously, the flexible moulding medium has a hardness in the range 7 to 17 Vickers and preferably around 8 to 12 Vickers.

Advantageously, the flexible moulding medium has a density in the range 1.2 to 2.0 and preferably around 1.3 to 1.8 g/cm³.

Preferably, the mould matrix material is a curable resin such as a urethane polymer cured by incubation for a short spell (about 1 to 4 hours) at 30 to 70° C. in the presence of an isocyanate cross-linking agent. Most preferably, the mould matrix material is a polyether-based polyurethane and typical properties for a suitable material in the nature cured state are given in the table below:

TABLE 1

| Property | Test Method | Value | Unit |
|---|---|---|---|
| Elongation at break | BS 903 Pt A2 | 200 | % |
| Shore Hardness | BS 2782 Meth 365B | 60 | ° D |
| Taber Abrasion (H22) | BS 903 Pt A9 Meth D | 215 | mg loss |
| Nicked Crescent Tear | ASTM D624 | 115 | N/mm |
| Strength | | | |
| Cold Flex | BS 2782 Meth 150B | −20 | ° C. |
| Temperature | | | |
| 100% Modulus | BS 903 Pt A2 | 19 | MPa |
| Tensile Strength | BS 903 Pt A2 | 23 | MPa |

It will be noted that the values given in the table above refer to the polyether polyurethane in its native cured state, and that its properties will be modified for application in the present invention by the addition of fibres and other optional additives.

Preferably, the-proportion of fibres by volume is from 30 to 70%, most preferably from 40 to 60%. Preferably the fibres are from 100 to 650 μm in length, most preferably from 200 to 400 μm. Preferably the fibre diameters are from 1 to 20 μm, most preferably from 12 to 14 μm. Carbon fibres are especially preferred.

The advantages of adding such fibres to the mould matrix material are that the mould, once formed, can be subjected to greater compressive forces because it shows enhanced strength relative to a fibre-free mould. As a result, the new tools can be used for injection moulding processes, where the typical moulding pressures range from 3.15 to 6.30 kg/mm² (2 to 4 tons-force per square inch). In fact, the tools have a compressive capability very much higher than the operating pressures likely to be encountered in present-day injection moulding techniques and have compressive capability up to 14.5 to 15.70 kg/mm² (9 to 10 tons-force per square inch).

The mould matrix material may additionally be loaded with a variety of fillers to regulate the properties of the hardened material which forms the flexible mould. For example, the material may include suspended particulate metal to improve the heat transfer characteristics of the cured mould. Alternatively, a material, such as glass or ceramic beads, could be added to impart better insulation capacity. Similarly, additives can be incorporated to influence hardness, rigidity, toughness, operating temperature range and such like in the cured mould.

The exact nature of the physical additives will vary according to the particular additive material in question. For example, in the case of particulate metal additives, the buoyancy of the additive particles relative to the matrix material must be taken into consideration. A buoyancy approaching neutrality is best, otherwise there may occur marked settlement of the added particulate material during hardening or cure of the matrix material. A certain degree of settlement is permissible and may even be desirable in some circumstances, for example in the preparation of a mould which needs to have its thermal conductivity boosted for moulding hot materials. If metal particles gravitate towards the split line during mould cure, thermal conductivity enhancement is greatest in the portion of the mould immediately surrounding the mould cavity. This makes the mould more tolerant of hot moulded product.

Generally, the fillers or additives are included in an amount ranging from 1 to 30% in proportions by volume measured relative to the total volume of the fibre-loaded mould matrix material. At proportions below 1% by volume, the additives tend to lose their effectiveness. At proportions greater than 30% by volume, the additives tend to dominate the physical properties of the fibre-loaded mould matrix material and some of the advantages of using a dynamic material are lost. In particular, the bond lengths formed in the cured material are relatively shorter and the cured matrix material therefore loses some of its rubber-like qualities. Also, the higher the filler content, the more difficult the material becomes to handle in its uncured state. For example, high filler and fibre contents mean that the material may be unsuitable for manual mixing.

Preferably, the additives are included in an amount ranging from 5 to 20% in proportions by volume, more particularly in an amount ranging from 10 to 15% by volume.

Typical non-conductive additives include talc, Molochite (Registered trade mark)—an alumino-silicate refractory material proprietary to English China Clay International, and glass. Typical particle sizes are 200 microns and below, and it will be understood by persons skilled in the art that additive particles should have an even granule size to encourage homogeneity in the mould during curing.

One of the primary functions of the filler material is to combat shrinkage in the fibre-loaded mould matrix material as it cools. It is important that the cured mould material is thermally stable in the sense that it has dimensional stability over its working temperature range. Typically, the unhardened mould matrix material is capable of being mixed and/or pressed over a temperature range of −10° C. to 200° C. and, once hardened, is able to accept a working range of moulding materials having melt flow temperatures varying between −40° C. and 600° C. At the upper limit of this working range, it is important to minimise the length of time for which the mould is exposed to elevated temperature, otherwise the mould may become permanently degraded to the detriment of moulding fidelity in the finished component. Therefore, it is advisable in such circumstances to load the mould matrix material with a conductive filler, such as steel particles, to distribute the thermal energy of the moulding material quickly through the mould.

Mild steel particles may be used as a filler for non-corrosive moulding materials, but stainless steel particles are preferred if the moulding material is in any way corrosive. For example, many rubber compositions include a high sulphur content which renders them highly corrosive. Stainless steel particles would therefore be recommended for moulding components from rubbers.

Besides fillers, which alter mould properties by physical means, it is also possible to influence the properties of the cured mould by chemical means, by varying the chemical formulation, such as changing the nature of the polymer or using a different blend of starting materials.

It is a key feature of the hardened mould that it possesses an elastic memory over the quoted operating temperature range. The elastic memory is defined at the time the material is pressed against the pattern and caused to harden—this sets the memory to the shape of the component master pattern. If the mould form is distorted during the moulding process, for example as a result of the mould clamping pressure, it has dynamic power to return to its original shape when the injection pressure is applied, counteracting any initial distortion.

It can be seen from the foregoing that the flexible medium can be changed to suit particular criteria and, in particular, to match the moulding requirements of a particular end product.

One of the key advantages of using this new material to form the mould cavity around a component master pattern is that the features of the pattern are faithfully reproduced, including surface finishes. Moreover, the flexible nature of the cured mould means that undercut formations on the component master pattern are not problematic: the pattern can be jumped from the cured mould with relative ease and the mould reverts to its unstressed form by virtue of its resilience. The same is true for moulded articles subsequently formed in the mould cavity vacated by the component master pattern.

It is also a clear advantage of the present invention that mould formation is so quick and faithful to the prototype, compared to conventional tool making methods, because minor changes to the tool configuration can be accommodated quickly and cheaply. Faithful reproduction of the component master pattern in the cured mould means that draft angles and fillets do not have to be incorporated at every stage, but can be introduced later during the design evaluation process when the exact fillet and draft angle requirements become fully evident.

Another advantage of the present invention is that it can be regulated to give flash-free moulding. In a conventional mould, the applied pressure acts only along the axis of the mould parts and there is a tendency for the material that is being moulded to creep along any lines of weakness, such as along the split lines which are generally oriented perpendicularly to the mould pressing axis. Increasing the moulding pressure may exaggerate the creep problem and it is therefore an acquired skill to judge what moulding conditions will be best, using conventional moulding techniques, for a particular product and/or material to minimise flash yet achieve good product integrity.

By contrast, the cured mould material used in the present invention is a flexible form which is capable of exerting equal pressures around the entire orientation of the mould cavity. Hence, an increase in the injection pressure is transmitted into the body of mould matrix material and results in an increase in the mating forces experienced between the mould halves at the split lines. Creep is thereby inhibited and flash-free products result. This is only possible because the mould matrix material is a dynamic material and remains flexible under the moulding pressures applied in the inventive process.

Persons skilled in the art will recognise that, in conventional moulding technology, increasing the injection pressure is likely to cause separation between the mould halves and increase the incidence of flash. The present invention therefore operates in completely the opposite sense from prior art teaching.

Other advantages and modifications of the invention will be apparent to persons skilled in the art from the present description.

The invention will now be described by way of example only with reference to the drawings, in which:

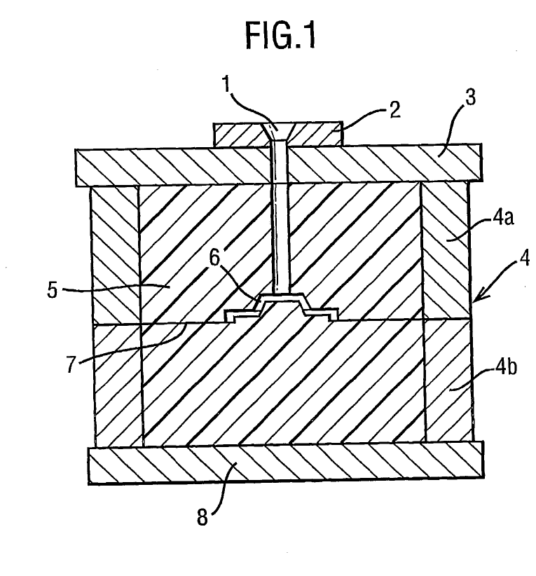

FIG. 1 is a schematic cross-sectional view of an assembled mould showing a mould cavity destined to be filled with moulding material;

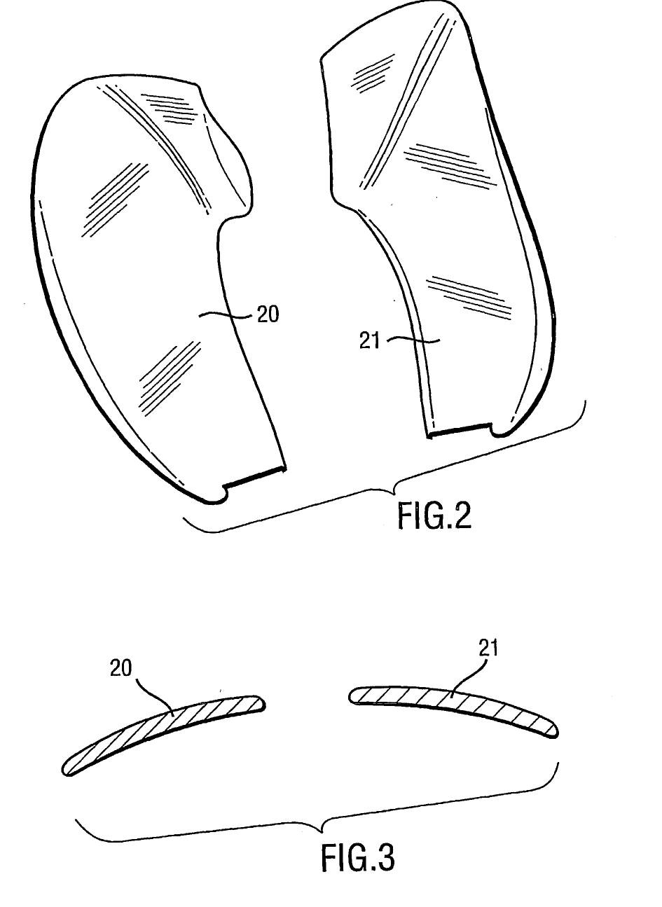

FIG. 2 is a schematic perspective view of a three-dimensional pattern in the form of a pair of vehicle mud-flaps;

FIG. 3 is a schematic cross-sectional view of the mud-flap patterns depicted in FIG. 2;

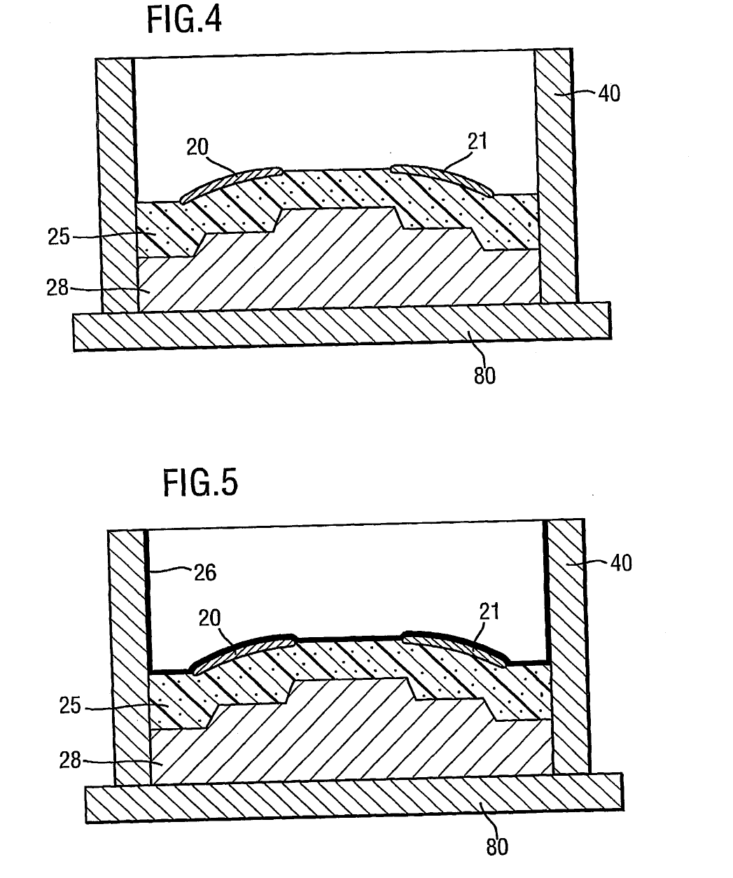

FIG. 4 is a schematic cross-sectional view depicting an early stage in the process of the present invention;

FIG. 5 is a schematic cross-sectional view similar to FIG. 4 showing the mud-flap patterns after application of a release coating;

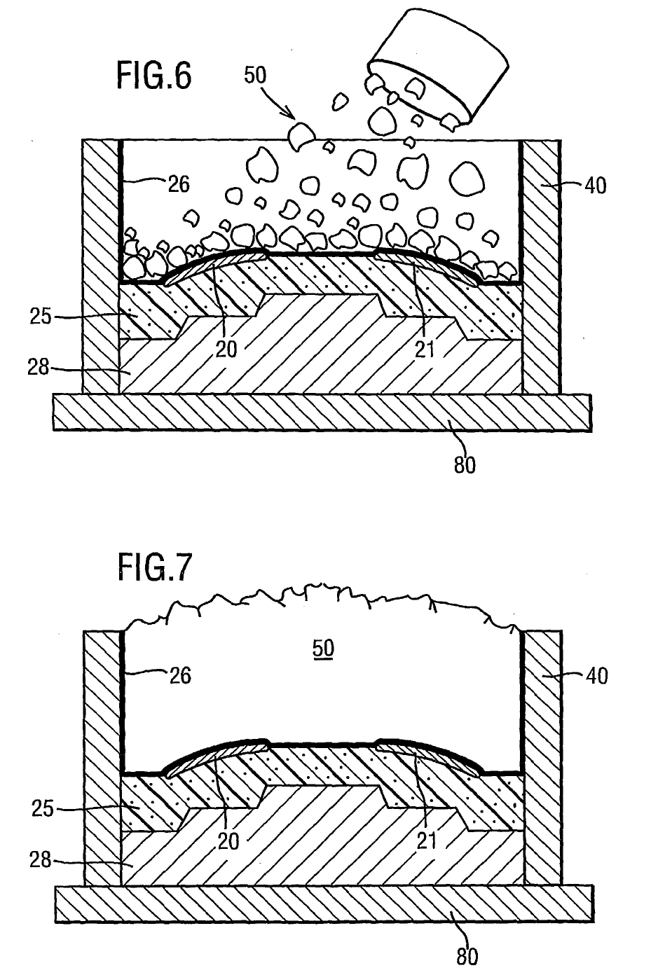

FIG. 6 is a schematic cross-sectional view showing addition of the fibre-loaded mould matrix material;

FIG. 7 is a schematic cross-sectional view similar to FIG. 6 after addition of the fibre-loaded mould matrix material has been completed;

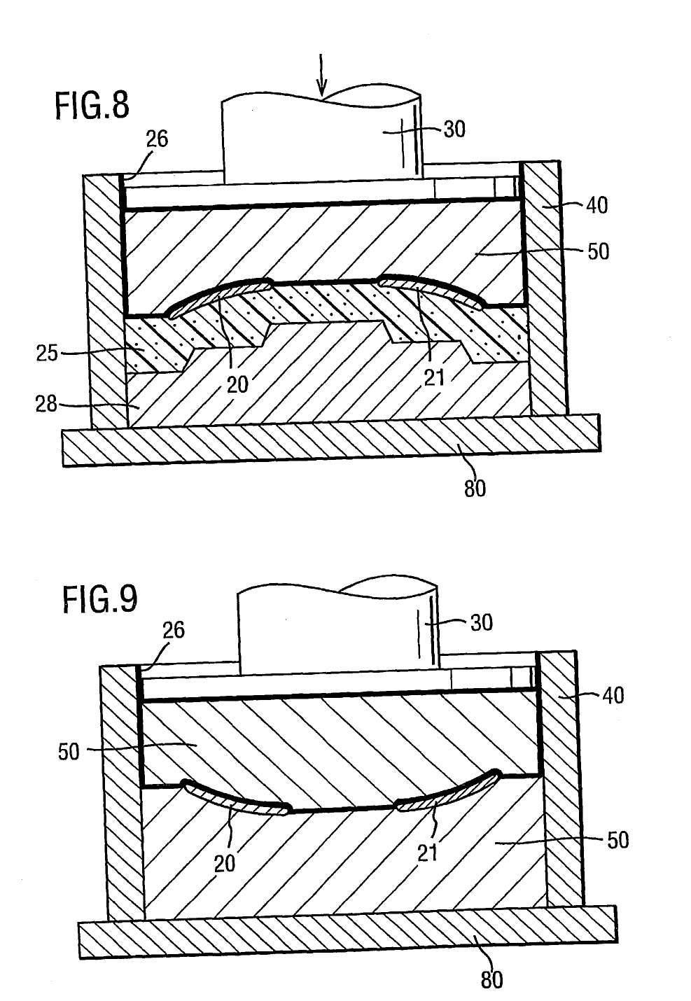

FIG. 8 is a schematic cross-sectional view showing the fibre-loaded mould matrix material being subjected to pressing by a piston;

FIG. 9 is a schematic cross-sectional view showing the second half of the mould being formed by pressing further fibre-loaded mould matrix material with a piston;

FIG. 10 is a schematic cross-sectional view showing the finished mould complete with machined injection sprue and;

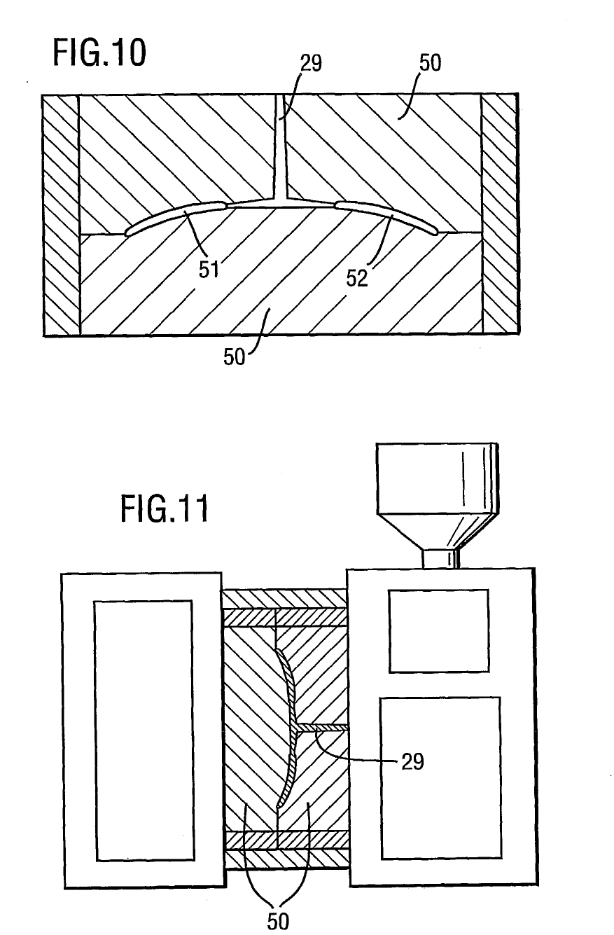

FIG. 11 is a schematic cross-sectional view showing the assembled mould in a production moulding machine.

Referring now to FIG. 1, an assembled mould is shown comprising steel retaining walls 4 defining upper and lower bolster members 4a, 4b. The upper bolster member 4a is bounded on its upper surface by a top plate 3 and the lower bolster member 4b is bounded on its lower surface by a bottom plate 8. The bottom plate 8 forms the base of a rigid container and is adapted to be fastened to the lower platen of a production moulding machine (not shown).

The chamber defined by the retaining walls 4 and top and bottom plates 3, 8 is largely filled with a flexible medium 5 comprising a carbon fibre composite material such as a loaded polyurethane resin. As discussed above, the carbon fibre composite material may contain a variety of additives to influence its properties according to the nature of the product that is being moulded.

The flexible medium 5 bounded by the upper bolster member 4a includes a channel extending from the exterior of the chamber, through the top plate 3, to a mould cavity 6. Mould cavity 6 will previously have been formed around a component master pattern in a manner to be described in more detail below. On the upper surface of top plate 3 there is provided an injection point 1 surrounded by a register ring 2 which serves to locate the mould assembly relative to an injection nozzle of a production moulding machine (not shown).

Split line 7 indicates the interface between the tool components. At the end of a moulding operation, the mould may be separated at this interface and the moulded component removed. The mould can then be reassembled and is ready for re-use.

The effectiveness of the mould in producing products which are accurate copies of masters is dependent on the physical properties of the flexible medium 5 being correctly selected.

The most important physical properties are flexural strength and modulus, tensile strength and modulus, compressive strength and modulus and hardness and density of the flexible medium.

Table 2 shows values and ranges for these physical properties.

In Table 2 three separate sets of physical properties are set out. The first broad range is the range within which the invention can be carried out, the second intermediate range sets sub-ranges which will normally provide better results and a third set of preferred values which will normally provide the best results.

TABLE 2

| | Broad | | Intermediate | | Preferred | |
|---|---|---|---|---|---|---|
| Flexural Strength | 20-175 | MPa | 30-80 | MPa | 50-60 | MPa |
| Flexural Modulus | 700-5000 | MPa | 1500-3500 | MPa | 2200-2700 | MPa |
| Tensile Strength | 10-120 | MPa | 20-60 | MPa | 25-35 | MPa |
| Tensile Modulus | 850-4000 | MPa | 1500-2500 | MPa | 1750-2250 | MPa |
| Compressive Strength | 30-200 | MPa | 50-105 | MPa | 75-85 | MPa |
| Compressive Modulus | 400-5000 | MPa | 500-2500 | MPa | 600-1500 | MPa |
| Hardness | 5-20 | Vickers | 7-17 | Vickers | 8-12 | Vickers |

| | | | |
|---|---|---|---|
| Density | 0.5-3.0 | 1.2-2.0 | 1.3-1.8 |

In practice of course it is not always possible to employ a flexible medium having physical properties about the preferred values or sometimes even within the intermediate advantageous ranges of values because of other criteria on which the selection of the flexible medium 5 must be made. Typically, such criteria can include cost or limitations imposed by the process by which the flexible medium 5 is formed. For example, where the flexible material 5 is produced by pressing a curable carbon fibre composition material around a master, the matrix material must be compatible with the material of the master and will have limitations imposed on its properties by the requirements of the pressing process.

In general, it has been found that, provided the physical properties of the flexible medium are within the first broad range in Table 1, acceptable results can be obtained although normally the results obtained will improve as more of the physical properties are brought within the second intermediate range and as close as possible to the preferred values.

At values below the lower limits given for the broad range, the invention is not viable. As mentioned above, it is a key feature of the hardened mould matrix material that it behaves elastically over the quoted operating temperature range. If the mechanical properties fall below the lower limits quoted for the broad range, the hardened mould matrix material does not perform as required under the applied injection moulding pressures. It tends to inflate instead, and cannot resile to the to the shape and form dictated by the component master pattern with resultant loss in fidelity.

Turning now to FIGS. 2 to 11, FIG. 2 is a schematic perspective view of a pair of three-dimensional master patterns 20, 21 in the form of vehicle mud-flaps which it is intended to reproduce in the material of the designer's choice for design verification purposes. Master patterns 20, 21 are shown in cross-section in FIG. 3.

FIG. 4 shows in schematic cross-sectional view an early stage in mould preparation. Master patterns 20, 21 are coated with a release agent and then partially embedded in a bed of so-called “blue” putty 25. This is a silicone putty used in dentistry, e.g., for taking dental impressions. In this particular example, the bed of blue putty 25 is formed on an aluminium block 28 which sits on the bottom plate 80. The purpose of the aluminium block 28 is to minimise the volume of blue putty 25 required. Any incompressible material could be used in place of the aluminium block 28.

When the release agent, which is an aqueous solution of polyvinyl acetate, has dried, the entire inner surface of the mould half is spray-coated with a thin layer of PTFE which fixes the polyvinyl acetate release agent in position and performs the function of secondary release agent. As an alternative, a silicone based material can be used as the release agent.

Then the blue putty 25 is cured. The cured putty has low shrinkage and good compressive capability, which are important in subsequent steps of the process, as will become apparent from the description below.

The release coatings are shown in FIG. 5 by the thick black line 26.

FIG. 6 shows the addition of fibre-loaded mould matrix material 50 to the mould half. The fibre-loaded mould matrix material 50 is a soft crumbly mixture in its uncured form. Usually, the fibre and filler contents of the mould matrix material are such that it has poor flow characteristics and must be pressed against the component master pattern or patterns to form a mould conforming faithfully to the surface of the pattern.

FIG. 7 shows the mould half after completion of the addition of the fibre-loaded mould matrix material 50. As shown in FIG. 8, a piston 30, the lower surface of which has previously been treated with the PVA release agent and the PTFE coating 26, is used to compress the fibre-loaded mould matrix material 50 so that it is pressed to conform to the surface of the master patterns 20, 21. The fibre-loaded mould matrix material will have been pre-mixed with a curative that results in hardening to a solid flexible material. The mould half is maintained under compression for between 1 and 4 hours at 30 to 70° C., until the matrix material has cured.

Once cured, the next stage of mould preparation can be carried out. The thus-formed mould half is removed and inverted. The aluminium block 28 and the blue putty 25 are also removed and then the inverted mould half is replaced in the bolster so that its former top surface is now in contact with the bottom plate 80. The master patterns 20, 21 may be given a further coating of PVA release agent on the newly-exposed surfaces thereof. When the release agent coating has dried, the entire interior surface of the mould half is given a thin spray-coating of PTFE, as before. Next, a second batch of fibre-loaded mould matrix material 50 is loaded into the mould half until it stands proud of the upstanding side walls 40. As before, the second batch of fibre-loaded mould matrix material 50 is subjected to compression by the piston 30 to press the material 50 into conformity with the surface features of the master patterns 20, 21. As before, the fibre-loaded mould matrix material 50 will have been pre-mixed with a curative that causes hardening to a solid flexible material. The assembly as depicted in FIG. 9 is then allowed to stand, for example, for between 1 to 4 hours at 30 to 70° C., until the second batch of the matrix material has cured.

In the next stage (not illustrated), the mould halves are separated and the master patterns 20, 21 are removed. Then, one of the mould halves is machined to form a sprue 29 which communicates from the outside of the mould half to the two mould cavities 51, 52. This is shown in FIG. 10. The material of choice can be injected into the mould cavities along the filling sprue 29 to produce prototype mouldings for design evaluation. Subject to satisfactory evaluation, the mould can then be used for production.

FIG. 11 illustrates the assembled mould in position in a production moulding machine. Moulding material is injected into the mould cavities 51, 52 along sprue 29.

Although the invention has been particularly described above with reference to a specific embodiment, it will be understood by a person skilled in the art that various modifications and adaptations are possible. For example, the process described above is silent with regard to surface treatment of the fibres. In practice, these may be treated with a bonding agent such as an organosilane which assists in binding the fibres to each other. This is helpful in ensuring that the cured composite material has good strength characteristics.

The fibres may be pre-treated to form fibrils. This can be done by adding a swelling agent which causes the fibres to swell, then subjecting them to a sudden freezing step, for example, by immersion in liquid nitrogen. This causes the fibre surfaces to split, forming microscopic fibrils on the surface. The fibres are then dried to remove any excess moisture that may be present from the swelling agent treatment. The fibrillated fibres are then mixed with mould matrix material and processed in the usual way.

It is also possible to apply a vacuum to the mould assembly during the compression and curing stage. This has the advantage of removing air from the cavity so that the piston does not have to do unnecessary work to compress air in addition to the fibre-loaded mould matrix material 50. The applied vacuum may be from 5.1 to 2.5×10⁴ Par, preferably from 2.5 to 1.5×10⁴ Pa and most preferably from 1.5×10⁴ to 5.1×10³ Pa.

Other variants may become apparent to persons skilled in the art without departing from the scope of the claims which follow.

1. A method of producing a mould by forming around a pattern of an article to be produced, the method comprising:
(a) pressing a mould matrix material around said pattern in a chamber bounded by solid retaining means;
(b) causing said mould matrix material to harden to produce a flexible mould having the following physical properties:
flexural strength in the range 20-175 MPa;
flexural modulus in the range 700-5,000 MPa;
tensile strength in the range 10-120 MPa;
tensile modulus in the range 850-4,000 MPa;
compressive strength in the range 30-200 MPa;
Compressive modulus in the range 400-5,000 MPa;
hardness in the range 5-20 Vickers;
relative density in the range 0.5 to 3.0 g/cm³, and
(c) removing the pattern to leave a mould conforming to the pattern;
wherein said mould matrix material contains from 10 to 90% by volume of fibres, said fibres having a length in the range from 10 to 1000 μm and a thickness in the range from 0.1 to 30 μm.

2. A method as claimed in claim 1 wherein the proportion of fibres by volume is from 30 to 70%.

3. A method as claimed in claim 1 wherein the proportion of fibres by volume is from 40 to 60%.

4. A method as claimed in any preceding claim wherein the fibres are refractory fibres.

5. A method as claimed in any preceding claim wherein the fibres are selected from the group consisting of carbon, aramid, boron nitride, ceramic, glass, buckminsterfullerene and nanotubes formed from the aforementioned materials.

6. A method as claimed in any preceding claim wherein the fibres are from 100 to 650 μm in length.

7. A method as claimed in any preceding claim wherein the fibres are from 200 to 400 μm in length.

8. A method as claimed in any preceding claim wherein the fibre diameters are from 1 to 20 μm.

9. A method as claimed in any preceding claim wherein the fibre diameters are from 12 to 14 μm.

10. A method as claimed in any preceding claim wherein the flexible moulding medium has a flexural strength in the range 30-80 MPa.

11. A method as claimed in claim 10 wherein the flexible moulding medium has a flexural strength of 50-60 MPa.

12. A method as claimed in any preceding claim wherein the flexible moulding medium has a flexural modulus in the range 1500 to 3500 MPa.

13. A method as claimed in claim 12 wherein the flexible moulding medium has a flexural modulus of 2200-2700 MPa.

14. A method as claimed in any preceding claim wherein the flexible moulding medium has a tensile strength in the range 20-60 MPa.

15. A method as claimed in claim 14 wherein the flexible moulding medium has a tensile strength of 25-35 MPa.

16. A method as claimed in any preceding claim, wherein the flexible moulding medium has a tensile modulus in the range 1500-2500 MPa.

17. A method as claimed in claim 16, wherein the flexible moulding medium has a tensile modulus of 1750-2250 MPa.

18. A method as claimed in any preceding claim, wherein the flexible moulding medium has a compressive strength in the range 50-105 MPa.

19. A method as claimed in claim 18, wherein the flexible moulding medium has a compressive strength of 75-85 MPa.

20. A method as claimed in any preceding claim, wherein the flexible moulding medium has a compressive modulus in the range 500-2500 MPa.

21. A method as claimed in claim 20, wherein the flexible moulding medium has a compressive modulus of 600-1500 MPa.

22. A method as claimed in any preceding claim, wherein the flexible moulding medium has a hardness in the range 7-17 Vickers.

23. A method as claimed in claim 22, wherein the flexible moulding medium has a hardness of 8-12 Vickers.

24. A method as claimed in any preceding claim, wherein the flexible moulding medium has a density in the range 1.2 to 2.0 g/cm³.

25. A method as claimed in claim 24, wherein the flexible moulding medium has a relative density of 1.3-1.8 g/cm.

26. A method of producing an article as claimed in any preceding claim, wherein the mould matrix material is a curable resin.

27. A method of producing an article as claimed in claim 26, wherein the curable resin is a urethane polymer cured by admixture with an isocyanate cross-linking agent.

28. A method of producing an article as claimed in claim 27, wherein the curable resin is a polyether-based polyurethane.

29. A method of producing an article as claimed in any preceding claim, wherein the mould matrix material is loaded with a variety of fillers or additives to adjust the properties of the hardened material.

30. A method of producing an article as claimed in claim 29, wherein the fillers or additives are included in an amount, ranging from 1 to 30% in proportions by volume measured relative to the volume of mould matrix material.

31. A method of producing an article as claimed in claim 30, wherein the fillers or additives are included in an amount ranging from 5 to 20% in proportions by volume measured relative to the volume of mould matrix material.

32. A method of producing an article as claimed in claim 31, wherein the fillers or additives are included in an amount ranging from 10 to 15% in proportions by volume measured relative to the volume of mould matrix material.

33. A method as claimed in any preceding claim wherein the fibres are pre-treated prior to mixing with the mould matrix material to promote intermeshing between fibres.

34. A method as claimed in claim 33 wherein the fibres are caused to split to form fibrils.

35. A method as claimed in claim 33 wherein the fibres are treated with a swelling agent and then frozen to cause the fibres to split.

36. A method as claimed in any preceding claim wherein the pattern is treated with a release agent.

37. A method as claimed in claim 36 wherein the release agent is polyvinyl acetate or a solution thereof.

38. A method as claimed in claim 37 wherein the release agent is coated with PTFE.

39. A method as claimed in any preceding claim wherein the step of pressing the mould matrix material around the pattern is carried out under partial vacuum.

40. A method of producing an article comprising forming a mould as claimed in any one of claims 1 to 40, forming or moulding the article in the mould under production representative conditions of temperature and pressure, and removing the article from the mould.

41. A method of flash-free moulding an article in a mould formed around a pattern of the article to be moulded, the method comprising:
(a) pressing a mould matrix material around said pattern in a chamber bounded by solid, inflexible retaining means;
(b) causing said mould matrix material to harden to produce a flexible mould having the following physical properties
flexural strength in the range 20-175 MPa;
flexural modulus in the range 700-5,000 MPa;
tensile strength in the range 10-120 MPa;
tensile modulus in the range 850-4,000 MPa;
compressive strength in the range 30-200 MPa;
compressive modulus in the range 400-5,000 MPa;
hardness in the range 5-20 Vickers7 and density in the range 0.5 to 3.0 g/cm³;
(C) removing the pattern to leave a mould conforming to the profile of the pattern;
(d) injecting material into the mould under predetermined conditions of temperature, and increasing the injection pressure such that the increase in pressure is transmitted into the body of the mould to increase the mating forces experienced between the mould halves at the split lines thereof, and
(e) removing the moulded article from the mould.

42. A method of producing a mould substantially as herein described with reference to FIG. 1 or with reference to FIGS. 2 to 11 of the drawings.

43. A mould tool comprising a mould matrix material having the following physical properties:
flexural strength in the range 20-175 MPa;
flexural modulus in the range 700-5,000 MPa;
tensile strength in the range 10-120 MPa;
tensile modulus in the range 850-4,000 MPa;
compressive strength in the range 30-200 MPa;
compressive modulus in the range 400-5,000 MPa;
hardness in the range 5-20 Vickers;
relative density in the range 0.5 to 3.0 g/cm³;
wherein said mould matrix material contains from 10 to 90% by volume of fibres, said fibres having a length in the range from 10 to 1000 μm and a thickness in the range from 0.1 to 30 μm.

44. A mould tool as claimed in claim 43 wherein the proportion of fibres by volume is from 30 to 70%.

45. A mould tool as claimed in claim 43 wherein the proportion of fibres by volume is from 40 to 60%.

46. A mould tool as claimed in any one of claims 43 to 45 wherein the fibres are refractory fibres.

47. A mould tool as claimed in any one of claims 43 to 46 wherein the fibres are selected from the group consisting of carbon, aramid, boron nitride, ceramic, glass, buckminsterfullerene and nanotubes formed from the aforementioned materials.

48. A mould tool as claimed in any one of claims 43 to 47 wherein the fibres are from 100 to 650 μm in length.

49. A mould tool as claimed in any one of claims 43 to 48 wherein the fibres are from 200 to 400 μm in length.

50. A mould tool as claimed in any one of claims 43 to 49 wherein the fibre diameters are from 1 to 20 μm.

51. A mould tool as claimed in any one of claims 43 to 50 wherein the fibre diameters are from 12 to 14 μm.

52. A mould tool as claimed in any one of claims 43 to 51 having a flexural strength in the range 30-80 MPa.

53. A mould tool as claimed in claim 52 having a flexural strength of 50-60 MPa.

54. A mould tool as claimed in any one of claims 43 to 53 having a flexural modulus in the range 1500 to 3500 MPa.

55. A mould tool as claimed in claim 54 having a flexural modulus of 2200-2700 MPa.

56. A mould tool as claimed in any one of claims 43 to 55 having a tensile strength in the range 20-60 MPa.

57. A mould tool as claimed in claim 56 having a tensile strength of 25-35 MPa.

58. A mould tool as claimed in any one of claims 43 to 57, having a tensile modulus in the range 1500-2500 MPa.

59. A mould tool as claimed in claim 58, having a tensile modulus of 1750-2250 MPa.

60. A mould tool as claimed in any one of claims 43 to 59, having a compressive strength in the range 50-105 Mpa.

61. A mould tool as claimed in claim 60, having a compressive strength of 75-85 MPa.

62. A mould tool as claimed in any one of claims 43 to 61, having a compressive modulus in the range 500-2500 MPa.

63. A mould tool as claimed in claim 62, having a compressive modulus of 600-1500 Mpa.

64. A mould tool as claimed in any one of claims 43 to 63, having a hardness in the range 7-17 Vickers.

65. A mould tool as claimed in claim 64, having a hardness of 8-12 Vickers.

66. A mould tool as claimed in any one of claims 43 to 65, having a density in the range 1.2 to 2.0 g/cm³.

67. A mould tool as claimed in claim 66, having a relative density of 1.3-1.8 g/cm³.

68. A mould tool as claimed in any one of claims 43 to 67, wherein the mould matrix material is a curable resin.

69. A mould tool as claimed in claim 68, wherein the curable resin is a urethane polymer cured by admixture with an isocyanate cross-linking agent.

70. A mould tool as claimed in claim 69, wherein the curable resin is a polyether-based polyurethane.

71. A mould tool as claimed in any one of claims 43 to 70, wherein the mould matrix material is loaded with a variety of filers or additives.

72. A mould tool as claimed in claim 71, wherein the tillers or additives are included in an amount ranging from 1 to 30% in proportions by volume measured relative to the volume of mould matrix material.

73. A mould tool as claimed in claim 72, wherein the fillers or additives are included in an amount ranging from 5 to 20% in proportions by volume measured relative to the volume of mould matrix material.

74. A mould tool as claimed in claim 73, wherein the fillers or additives are included in an amount ranging from 10 to 15% in proportions by volume measured relative to the volume of mould matrix material.

75. A mould tool as claimed in any one of claims 43 to 74 wherein the fibres are pre-treated prior to mixing with the mould matrix material to promote intermeshing between fibres.

76. A mould tool as claimed in claim 75, wherein the fibres are caused to split to form fibrils.

77. A mould tool as claimed in claim 75 wherein the fibres are treated with a swelling agent and then frozen to cause the fibres to split.

78. A kit of parts for producing a mould tool according to any one of claims 43 to 77, comprising:
(a) a quantity of mould matrix material;
(b) a quantity of fibres, and
(c) a set of instructions regarding the relative quantities of mould matrix material and fibres required.

79. A kit of parts as claimed in claim 78 further comprising a release agent for application to a component master pattern around which the mould tool is destined to be formed.

80. A, kit of parts as claimed in claim 79 wherein the release agent is polyvinyl acetate or a solution thereof.

81. A kit of parts as claimed in claim 80 further comprising PTFE for coating the release agent.
